(19) United States
(12) Patent Application Publication
(10) Pub. No.: US 2005/0174893 A1
(43) Pub. Date: Aug. 11, 2005

(54) Balance for a clockwork movement

(75) Inventor: Jean Remont, Les Rousses (FR)

Correspondence Address: SUGHRUE MION, PLLC, 2100 PENNSYLVANIA AVENUE, N.W., SUITE 800, WASHINGTON, DC, 20037, US

(73) Assignee: MONTRES BREGUET SA

(21) Appl. No.: 11/045,102

(22) Filed: Jan. 31, 2005

(30) Foreign Application Priority Data
Feb. 5, 2004 (EP) 04002540.5

(51) Int. Cl. G06F 1/04

(52) U.S. Cl. 368/127

(57) ABSTRACT

In order to make a wheel-shaped balance (1) lighter, while maintaining sufficient mechanical resistance and good dimensional stability as regards temperature variations, the felloe (3) and the arms (2) of the balance are made of titanium or a titanium-based alloy. This enables a sprung balance oscillator to be made with a larger diameter than normal for the same frequency, or having a higher frequency with the same dimensions as a usual oscillator.

This application claims priority from European Patent Application No. 04002540.5 filed Feb. 5, 2004, the entire disclosure of which is incorporated herein by reference.

### BACKGROUND OF THE INVENTION

The present invention concerns a balance for a clockwork movement, comprising a staff, a rim and arms connecting the rim to the staff, and intended to be associated with a balance spring to form, in a conventional manner, the mechanical oscillator that determines the basic frequency of the movement of a timepiece, in particular of a watch. A known construction of a balance of such type is illustrated for example in CH Patent No. 494 992.

Currently, in a balance for a watch movement, the wheel-shaped part including the rim (or felloe) and the arms is made of a copper-based alloy, particularly beryllium copper or German silver, or nickel. Such an alloy offers an advantageous combination of qualities which include, in particular, its non-magnetic nature, good chemical stability and sufficient mechanical properties. The density of these alloys is greater than 8 kg/dm³. Their thermal expansion coefficient, which is around 17·10⁻⁶/° C. for CuBe, around 15·10⁻⁶/° C. for nickel and around 21·10⁻⁶/° C. for nickel silver, is not particularly favourable.

The oscillation frequency f of a sprung balance oscillator is given by:
1/f=2π·(I/M)^{0,5}
where I is the moment of inertia of the balance about its axis of rotation and M is the elastic torque of the spring, expressed in Nm/rad. The usual frequencies of watch oscillators are spread out from 2.5 Hz to 5 Hz, by steps of 0.5 Hz so that a period of one second corresponds to an integer number of oscillator vibrations. A movement is thus designed for a given frequency and the sprung balance assembly has to have that frequency. In the formula hereinabove, it can be seen that the pertinent balance parameter is the moment of inertia. Since the share of the balance arms is very low in the moment of inertia, the latter depends above all upon the dimensions (diameter and cross section) and density of the rim.

In some cases, the designer of a watch movement may wish to use a balance of relatively large diameter, for example for aesthetical reasons. Increasing the diameter without changing the moment of inertia can be achieved either by reducing the section of the rim, or by using a material of lower density. In both cases, the mass of the balance will be less, which reduces friction in the bearings, and thus the interference in the isochronism of the balance as a function of the (vertical and horizontal) positions of the movement. However, a rim of reduced section becomes too weak, especially if it has to carry adjusting screws. One can then envisage using a lighter material.

FR Patent No. 1 275 357 provides a lightened watch movement, by combining a rim made of a light metal, such as aluminium with a wheel-shaped elastic support element, formed by a circle and spokes, the circle having external lugs for securing it to the rim. This enables a wheel with high mechanical properties to be made, for example a spring steel. A similar solution, but without any fixing lugs, is provided in FR Patent No. 1 301 938.

However, such a balance construction, comprising two parts made of different materials, does not offer the same guarantees as to durability and stability of shape as a single part construction, particularly because of the great differences in thermal expansion between steel, aluminium-based alloys and copper-based alloys. These expansions and the deformations that they can cause considerably alter the moment of inertia and thus the oscillation frequency, especially with a rim made of aluminium. Moreover, with this two-part construction, it is difficult to centre the rim properly with respect to the axis of rotation.

### SUMMARY OF THE INVENTION

It is an object of the present invention to make a sprung balance oscillator having a larger diameter than normal for the same frequency, or having a higher frequency with the same dimensions as a usual oscillator, avoiding the aforementioned drawbacks. It is a particular object of the invention to make the balance lighter while maintaining sufficient mechanical resistance and good dimensional stability as regards temperature variations.

Thus, a balance in accordance with the invention is characterised in that the rim and the arms are made of titanium or a titanium-based alloy. Preferably, the rim and the arms are made in a single piece, which is a great advantage with respect to the two aforecited French Patents, but it is possible for these pieces to be manufactured separately, then assembled by welding or other means.

If choosing titanium, from among other light metals, in order to make a watch balance wheel, has never been envisaged until now, whereas aluminium has been for decades, this is probably because of anticipated machining difficulties. Utility Model DE 1 987 070, published in 1968, mentioned the possibility of using a light metal such as aluminium or titanium instead of beryllium copper for making a watch escapement wheel, which is a flat wheel that rotates rather slowly. However, to our knowledge, there has been no industrial use of titanium in a wheel of this kind. Moreover, the physical properties required for the materials of a balance wheel are quite different or higher than for another wheel of a watch or clockwork movement. Surprisingly, the selection of titanium for this particular application exhibits a host of technical advantages enabling a balance wheel that is both light and of high quality to be made: non-magnetic nature, low density, high mechanical resistance, low thermal expansion coefficient, resistance to corrosion. Compared to beryllium copper, titanium is almost two times lighter and expands thermally half as much, while offering equally good mechanical properties. Compared to aluminium, titanium is a little heavier, but has much better mechanical properties and a third of the thermal expansion of aluminium. The invention thus enables a balance wheel to be accomplished in a single piece, with a relatively light rim, despite its relatively large dimensions, whereas the arms are thin and elastic yet sufficiently solid.

Moreover, in comparison with a balance made of a conventional material having a relatively thin rim, a balance of the same diameter made of titanium may have a higher rim (in the direction parallel to the axis of rotation), which enables threaded holes to be arranged in the rim for balancing screws in cases where this would not have been possible in a rim made of a conventional material.

### BRIEF DESCRIPTION OF THE DRAWINGS

Other features of the invention will appear in the following description of an embodiment of a balance for a watch movement having a titanium balance wheel, presented by way of non limiting example of the invention with reference to the annexed drawings, in which:

FIG. 1 is a perspective view of the balance, and

FIG. 2 is a cross-section along the line II-II of FIG. 1.

### DETAILED DESCRIPTION OF ONE EMBODIMENT OF THE INVENTION

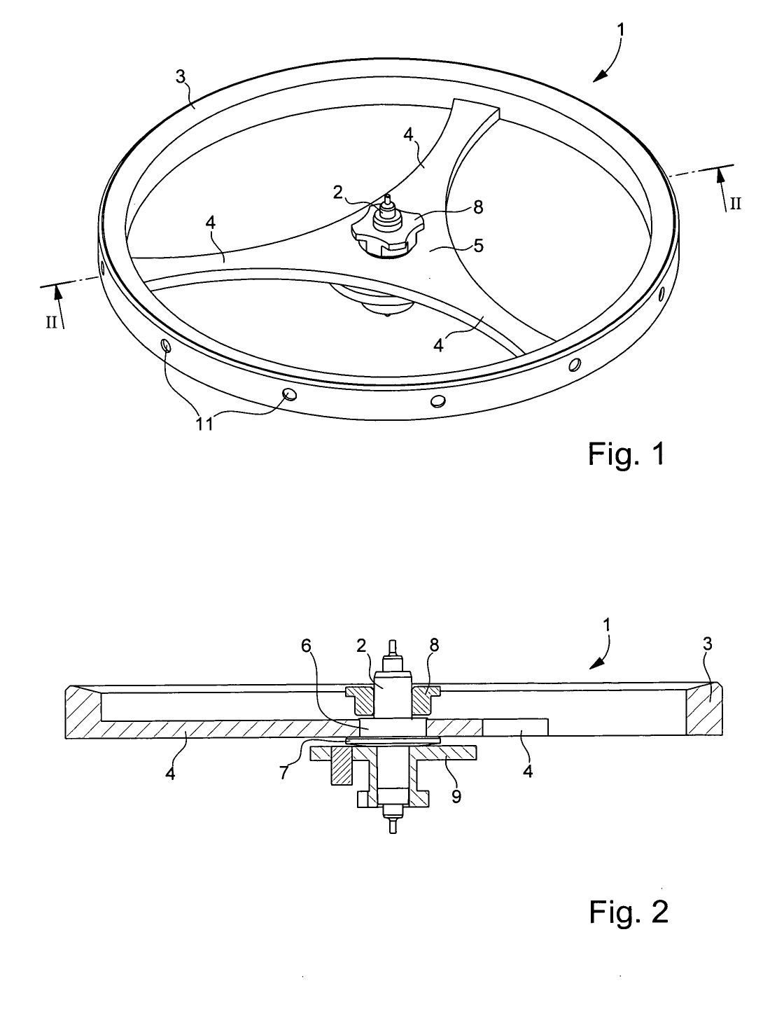

Balance 1 shown in FIGS. 1 and 2 includes a conventional steel staff 2 which supports a balance wheel including a rim 3 and, for example, three arms 4 made in a single piece with the rim. This piece is made of titanium or a titanium-based alloy, for the reasons of lightness explained hereinbefore. Arms 4 radiate from a pierced central part 5, which is driven onto a step 6 of staff 2 abutting against a shoulder 7. In a conventional manner, staff 2 also supports a collet 8 for securing a spring that is not shown, and a double roller 9 for cooperating with an escape lever.

The following alloys, for example, can be used:
Grade 2 titanium: AFNOR T40 (Fe 0.25%, O 0.048%, C 0.06%, N 0.05%, H 0.013%, remainder—titanium)
Grade 5 titanium: AFNOR TA6V6E2 (Al 5.5%, V 5.5%, Fe 0.6%, N 0.04%, Sn 2%, Cu 0.6%, remainder—titanium)

Owing to the low density of titanium, the rim 3, which in this case has a trapezoid cross section, is sufficiently high, thick and resistant to comprise threaded holes for receiving adjusting screws if needed. In the present case, the balance is not balanced by means of adjusting screws, but by milling recesses 11 in the external face of the rim.

Starting from the idea that balance 1 is made of titanium (density 4.5 kg/dm³), in order to have a larger diameter than a conventional beryllium copper balance (density 8.25 kg/dm³) having the same moment of inertia, also keeping the same cross section of the rim, it can be calculated that the mean diameter of the titanium balance rim will be enlarged by 22%. The effect obtained from the aesthetical point of view is thus significant, without leading to any loss in the mechanical properties of the rim.

1. A balance for a clockwork movement, comprising a staff, a rim and arms connecting the felle to the arbour, wherein the rim and the arms are made of titanium or a titanium-based alloy.

2. The balance of claim 1, wherein the rim and the arms are made in a single piece.

3. The balance of claim 1, wherein the staff is made of steel.
